(19) United States
(12) Patent Application Publication
(10) Pub. No.: US 2017/0157632 A1
(43) Pub. Date: Jun. 8, 2017

(54) TRIGGER-DISPENSING DEVICE FOR TWO OR MORE LIQUIDS

(71) Applicant: THE CLOROX COMPANY, Oakland, CA (US)

(72) Inventor: Riccardo ALLUIGI, Alessandria (IT)

(21) Appl. No.: 15/437,144

(22) Filed: Feb. 20, 2017

Related U.S. Application Data
(63) Continuation of application No. 14/683,232, filed on Apr. 10, 2015, now Pat. No. 9,610,598.

(30) Foreign Application Priority Data
Apr. 18, 2014 (IT) BS2014A000085

(51) Int. Cl. B05B 11/00

(52) U.S. Cl. CPC B05B 11/3085; B05B 11/0078; B05B 11/3011; B05B 11/007; B05B 11/3014; B05B 11/3025; B05B 11/3057; B05B 11/3059; B05B 11/3069

(57) ABSTRACT

A trigger head for a dispensing device for at least two substances including a pumping system to compress the substances separately and simultaneously before dispensing.

### CROSS-REFERENCE TO RELATED APPLICATIONS

This application is a continuation of and claims priority to U.S. Non-provisional application entitled “TRIGGER-DISPENSING DEVICE FOR TWO OR MORE LIQUIDS”: having the Ser. No. 14/683,232, filed Apr. 10, 2015, which claims priority to Italian Patent Application serial number BS2014A000085, entitled: “TRIGGER-DISPENSING DEVICE FOR TWO OR MORE LIQUIDS”: filed Apr. 18, 2014, which are herein incorporated by reference in their entirety.

### BACKGROUND

Technical Field

This invention refers to a manual trigger-dispensing device for liquids for at least two substances, generally liquids, for example for the hygiene of the home, the deodorization of rooms, the treatment of fabrics before ironing, and the like.

Description of the Related Art

Trigger devices are very widespread, as can be seen on supermarket shelves, especially for their ease of use and functionality. Every year many hundreds of millions of pieces are produced.

Among the numerous types, there are devices for two or more substances, particularly appreciated in applications such as hygiene of the home. In fact, it was found that the combination of several substances provides accentuated action, for example sanitizing, if the combination takes place shortly before dispensing from the device or even if the combination is realized on the surface itself.

There are numerous trigger-dispensing device solutions for two or more substances.

However, the solutions of the prior art sometimes have the drawback of not achieving a good mixture of the substances to be combined, frustrating, as was said above, the main purpose of this type of devices.

### SUMMARY OF THE DISCLOSURE

The purpose of this invention is to provide a trigger-dispensing device for two or more substances that meets the needs of the sector and overcomes the drawbacks referred to above.

This purpose is achieved by a trigger head of a trigger device, wherein the head comprises a trigger and pumping means operable by the trigger to aspirate simultaneously at least two substances and achieve dispensing, wherein the means for pumping are in addition suitable for carrying out a predetermined pre-compression of these substances, separately and simultaneously before dispensing.

### BRIEF DESCRIPTION OF THE DRAWINGS

FIG. 1 is a trigger-dispensing device for two substances according to an embodiment of this invention, comprising a dispensing head and a bottle (shown separately in the figure);

FIG. 2 is the dispensing head of the device of FIG. 1, with parts separated;

FIG. 3 illustrates the dispensing head according to a front view;

FIG. 4 illustrates the dispensing head according to a rear view;

FIG. 5 shows a sectional view of the dispensing head;

FIG. 6 illustrates the dispensing head according to a further observation point;

FIG. 7 shows an enlargement of detail VII in FIG. 6;

FIG. 8 shows a sectional view of the dispensing head of FIG. 5, without cover;

FIGS. 9a to 9c illustrate the dispensing head, respectively, in a locked configuration, an unlocked and partially actuated configuration and in a final actuated configuration;

FIG. 10 shows a pre-compression valve of the dispensing head according to a further embodiment of the invention;

FIG. 11 shows a pre-compression valve of the dispensing head according to a further embodiment of the invention.

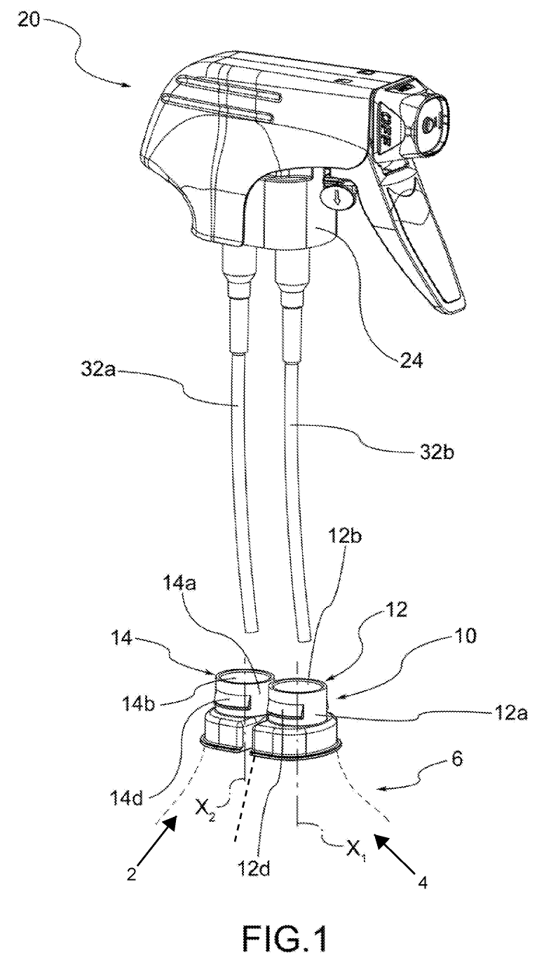

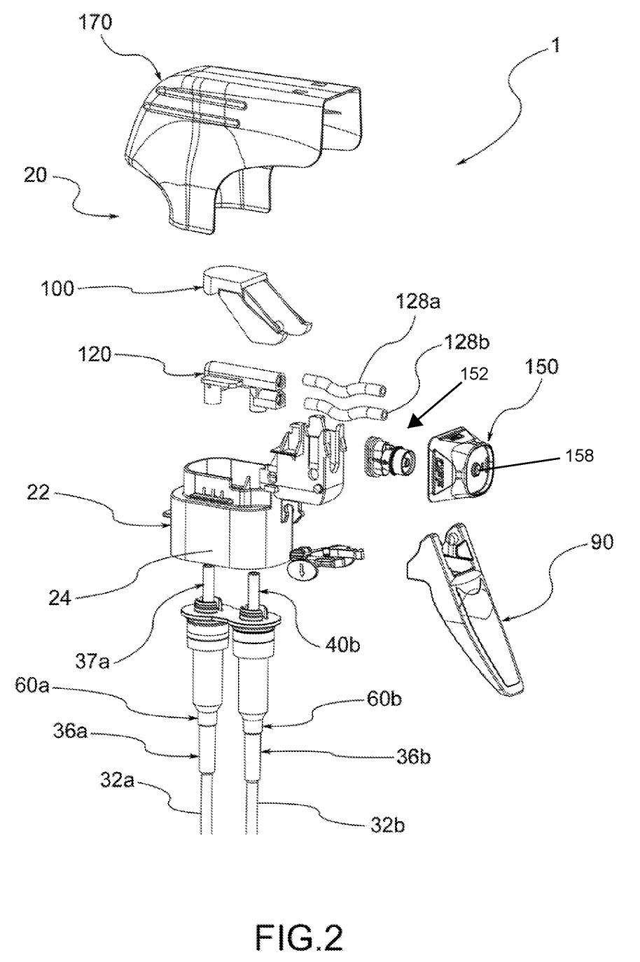

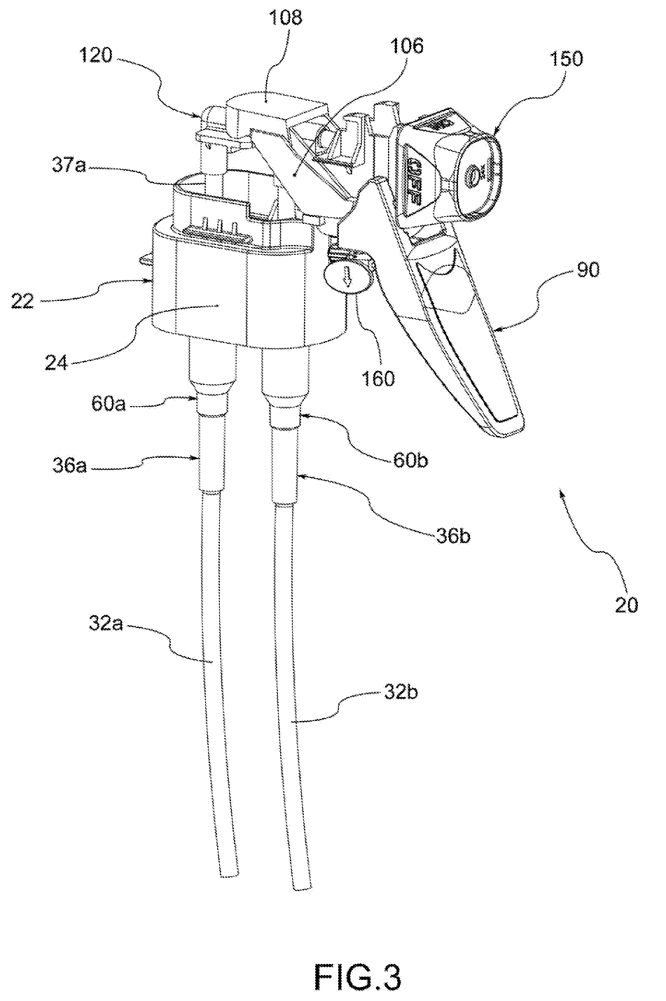

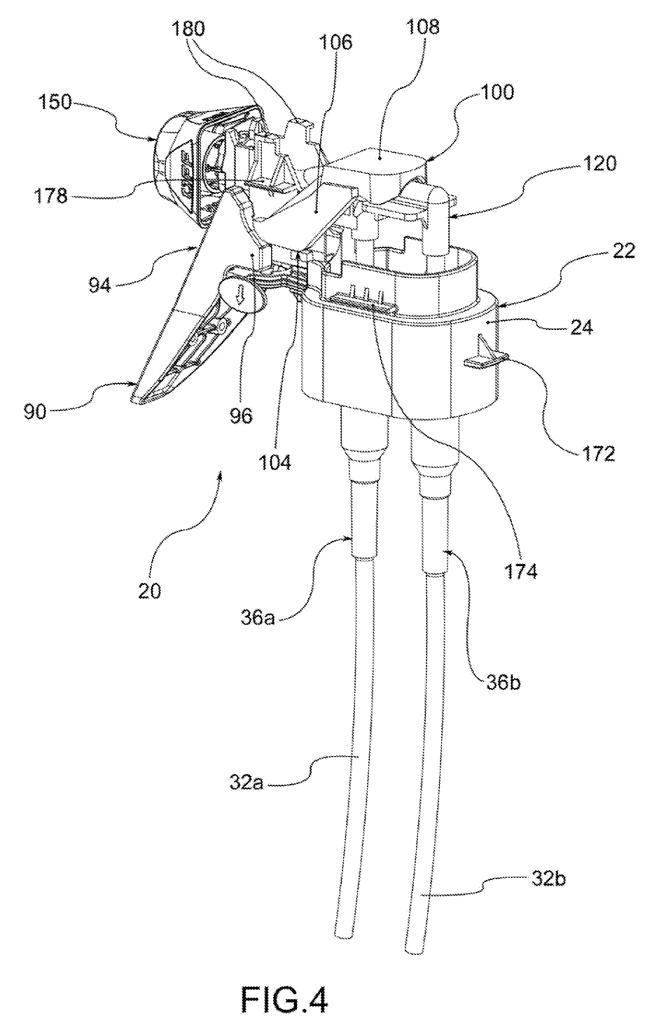

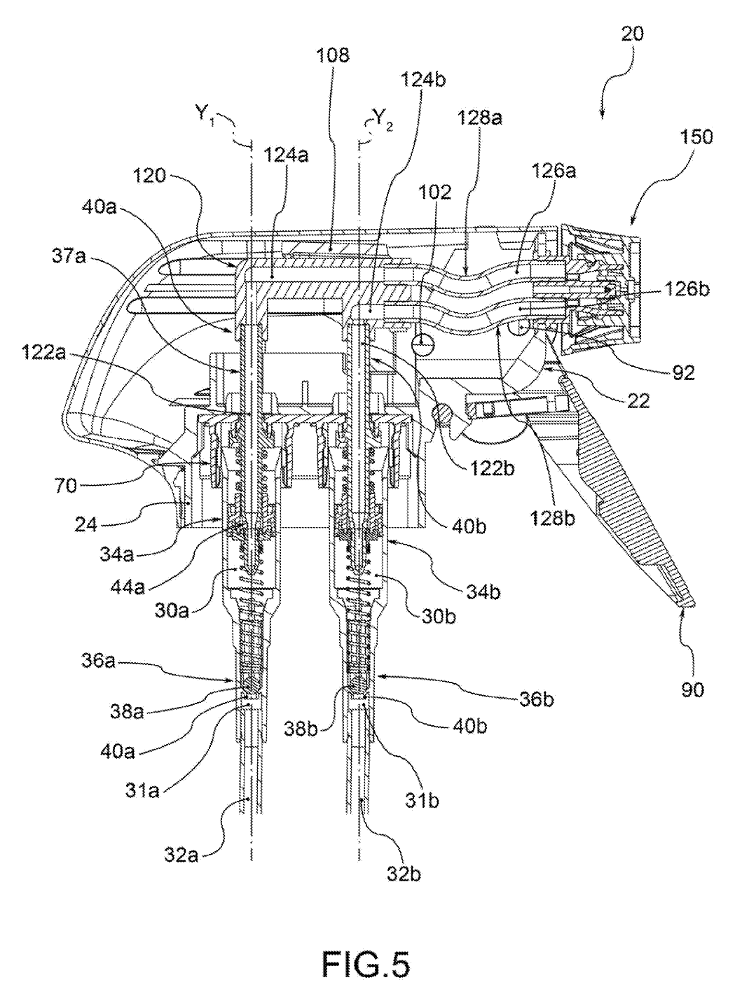

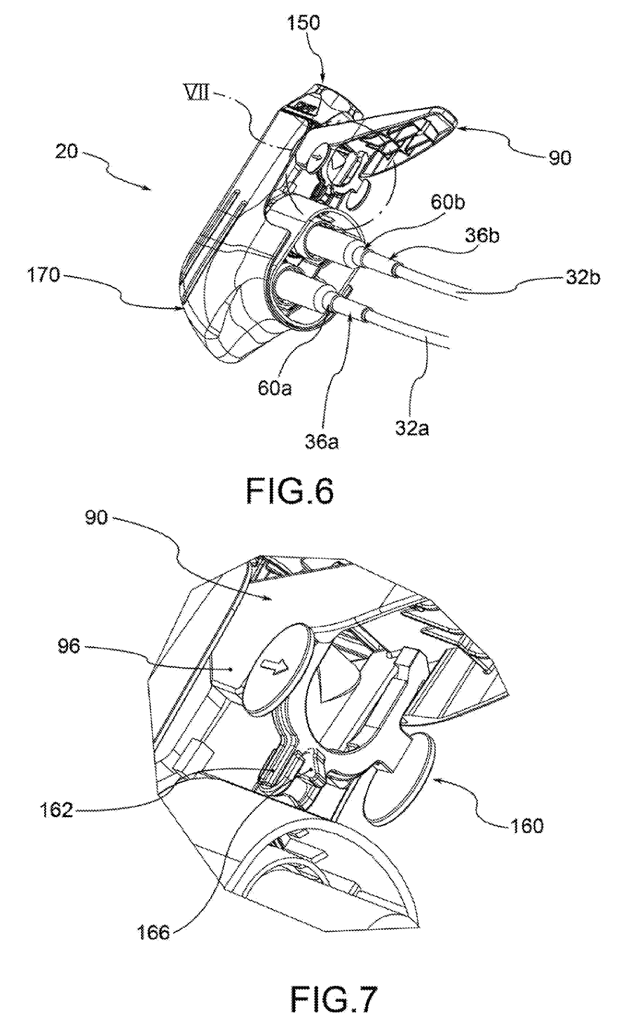

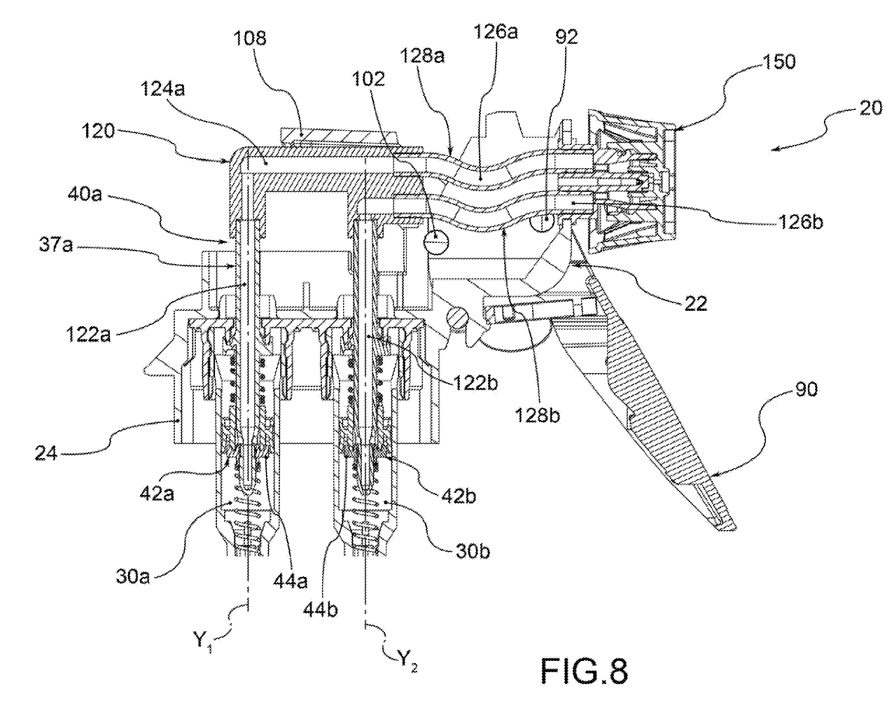

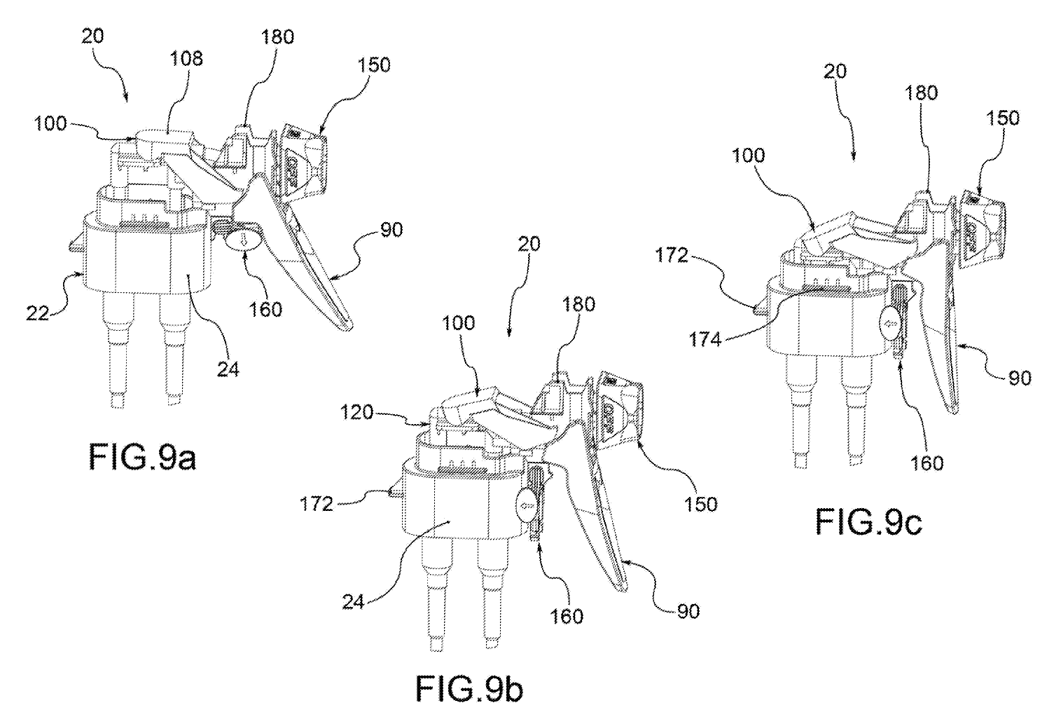

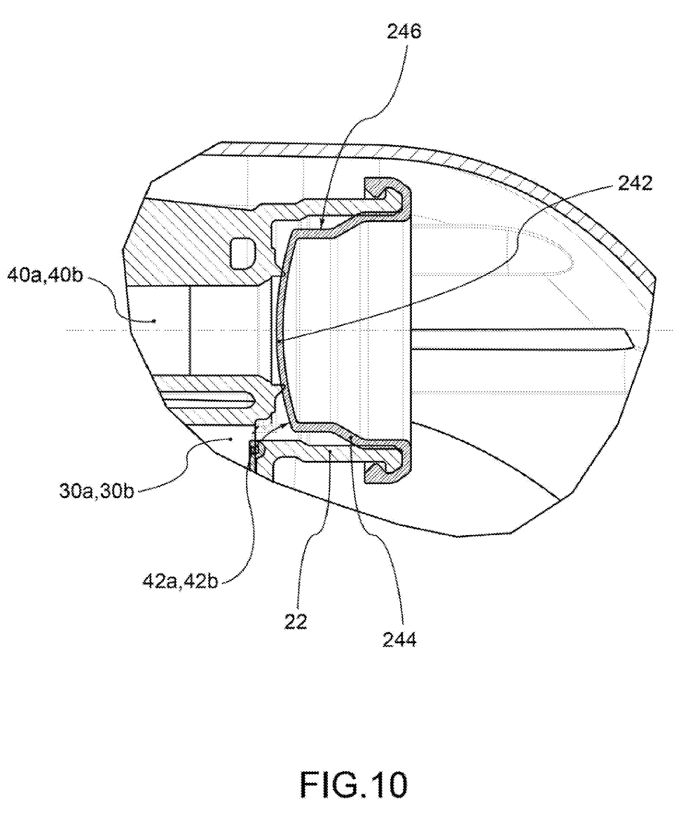

### DETAILED DESCRIPTION

With reference to the accompanying, 1 generally indicates a trigger dispensing device for two or more substances, generally liquids before dispensing.

For clarity of exposition, hereinafter we will refer to variants of the invention for two substances, without precluding the extension of the innovative features to more than two substances.

The device 1 comprises a first containment compartment and a second containment, separated from each other, respectively for the containment of a first substance and a second substance, usually liquids.

For example, the device 1 comprises a bottle 6 made in a single piece, for example of plastic, provided internally with a partition wall that separates the two containment compartments.

Preferably, the bottle 6 includes a bottle coupling portion 10 for the attachment of a pre-assembled dispensing head 20.

For example, the bottle coupling portion 10 includes a first neck 12 and a second neck 14, comprising respective annular neck walls 12a, 14a, for example cylindrical, that define respective rectilinear coupling axes X1,X2, parallel to each other.

The neck walls 12a,14a define respective openings 12b,14b for access to the respective containment compartments.

Preferably, the dispensing head 20 can be snap-coupled to the bottle 6.

For example, the coupling portion includes fins for snap coupling; for example, each neck 12, 14 comprises coupling fins 12d,14d, protruding outward from the respective neck wall 12a,14a.

For example, the coupling fins form two pairs, one for each neck 12,14; preferably, the fins of each pair have the same angular extension and are arranged symmetrically protruding from the neck, with respect to an imaginary plane containing the two coupling axes X1,X2.

The dispensing head 20 is preferably pre-assembled and applied to the bottle 6 after filling of the bottle with the substances to be dispensed.

The head 20 comprises a frame or chassis 22 for the support of the components. Preferably, the frame 22 can be snap-coupled to the bottle 6.

For example, the frame 22 comprises an annular coupling head wall 24 suitable to externally surround the necks 12, 14 of the bottle, provided with counter-coupling fins for snap engagement with the fins 12d,14d of the necks 12,14.

The head 20 comprises pumping means suitable to operate to simultaneously achieve the suction and pre-compression of two or more substances, and the separate or combined dispensing of the substances.

The pumping means comprise a first pressure chamber 30a and a second pressure chamber 30b suitable to be placed in communication respectively with the first containment compartment and the second containment compartment of the bottle 6, through respective inlet openings 31a,31b, for example by means of respective tubes 32a,32b applied to the inlet openings 31a,31b.

Furthermore, the head 20 comprises a first dispensing duct 40a and a second dispensing duct 40b for the dispensing of the substances from the respective pressure chambers 30a,30b.

The pumping means further comprise a first piston 34a and a second piston 34b suitable to operate in the respective pressure chambers 30a,30b to pressurize the substances contained therein, for example, for translation along respective piston axes Y1,Y2.

Preferably, each piston 34a,34b comprises a piston head 35a,35b and a piston rod 37a,37b, that extend along the respective piston axes Y1,Y2 and that support the respective piston heads 35a,35b.

Furthermore, the pressure means comprise suction valve means suitable to allow the transit of a substance from a respective containment compartment 2,4 of the bottle to the respective pressure chamber 30a,30b during a suction phase and prevent the return of the substance from the respective pressure chamber 30a,30b to the respective containment compartment 2,4 during a pre-compression step.

For example, the suction valve means comprise a first check valve 36a, positioned between a first inlet opening 31a and the first pressure chamber 30a, and a second check valve 36b, positioned between a second inlet opening 31b and the second pressure chamber 30b.

According to an embodiment, the check valves 36a,36b comprise an obturator 38a,38b, sensitive to the action of the substance present in the pressure chamber 30a,30b, for example in the form a ball, and an obturator seat.

In addition, the pumping means comprises pre-compression valve means suitable to allow the passage of substances from respective pressure chambers 30a,30b to the respective delivery ducts 40a,40b when the pressure of the substances in the pressure chambers exceeds a predefined threshold pressure and suitable to prevent the transit of the substances from the respective pressure chambers 30a,30b to the respective delivery ducts 40a,40b when the pressure of the substances in the pressure chambers is less than a predefined threshold pressure.

Preferably, the pressure threshold is greater than 1 bar; more preferably, the pressure threshold is greater than 3 bar.

For example, the pre-compression valve means comprise a first pre-compression valve 42a, operating between the first pressure chamber 30a and the first delivery duct 40a, and a second pre-compression valve 42b, operating between the second pressure chamber 30b and the second delivery duct 40b.

For example, the pre-compression valves 42a,42b each comprise an obturator plate 44a,44b, a piston head body 46a,46b, a pre-compression spring 48a,48b (which presses on the piston head body 46a,46b) and a return spring 50a,50b (which presses on the obturator plate 44a,44b).

In the step of simultaneous pre-compression of the substances, the pre-compression spring 48a,48b and the return spring 50a,50b, which work in an antagonistic manner, hold integral between them the obturator plate 44a,44b and the piston head body 46a,46b, closing the access of the pressure chamber 30a,30b to the respective delivery duct 40a,40b.

The assembly formed by the obturator plate 44a,44b and the piston head body 46a operates from the piston head 35a,35b, which compresses the substance in the pressure chamber 30a,30b.

The action of the piston 34a,34b produces a pressure increase in the pressure chamber 30a,30b, until the predetermined threshold pressure is exceeded.

Since the pre-compression spring 50a,50b works in opposition to the action of the pressure in the pressure chamber 30a,30b, upon reaching the threshold pressure, the piston head body 46a,46b separates from the obturator plate 44a,44b, opening the access to the respective delivery duct 40a,40b, simultaneously for the two substances.

Preferably, the pumping means comprise a first hollow casing 60a and a second hollow casing 60b, having prevailing extension along the respective piston axes Y1,Y2.

Inside each casing 60a,60b, the pressure chamber 30a,30b is formed, the piston 34a,34b is operating, for example, slidingly, and the check valve 36a,36b and the pre-compression valve 42a,42b are housed.

Preferably the head 20 comprises a connecting flange 70 for the simultaneous connection of the two casings 60a,60b to the frame 22.

The casings 60a,60b are applied to the flange 70, which is, in turn, affixed to the frame 22, and from the flange the piston rods 37a,37b protrude axially.

Furthermore, the head 20 comprises a trigger 90 hinged to the frame 22 at a trigger-connection point 90, and actuation means, operable from the trigger 90, for the simultaneous activation of the pistons 34a,34b.

In a preferred embodiment, the actuation means comprise a transmission member 100, hinged to the frame 22 at a pivot point 102, engageable by the trigger 90, so that a rotation of the trigger 90 corresponds to a counter-rotation of the transmission member 100.

In particular, having defined an imaginary plane containing the two pistons axes Y1,Y2, for the head 20 (and for the device 1), a right side is defined by one part of the imaginary plane, and a left side by the other part. Preferably, the imaginary plane so defined intersects the trigger 90.

Preferably, the trigger 90 comprises a trigger engagement portion 94 for engagement with the transmission member 100, wherein the portion 94 includes two protrusions 96, one on one side and one on the other side of the head.

Similarly, the transmission member 100 comprises an engagement organ portion 104 for engagement with the trigger 90, wherein the portion 104 comprises two elongations 96, one on one side and one on the other side of the head.

The transmission member 100 also includes a main portion 108, straddling between the sides of the head 20, from which protrude the elongations 106, due to the simultaneous action on the pistons 34a,34b.

Moreover, the actuation means comprise, preferably, an intermediate body 120, engageable by the transmission member 100 and suitable to translate along the pistons axes Y1,Y2.

The two pistons 34a,34b, and in particular the two piston rods 37a,37b, are integrally connected to the intermediate body 120.

In other words, the rotation of the trigger 90, for example clockwise, by manual action of a user of the device 1, causes the counter-rotation, for example counter-clockwise, of the transmission member 100, that goes to push the intermediate body 120, to which are integrally connected the two pistons 34a,34b, which are so actuated in compression.

According to a preferred embodiment, as shown, the delivery ducts 40a,40b pass through the piston rods 37a,37b and the intermediate body 102.

In particular, each delivery duct 40a,40b includes an initial section 122a,122b that extends inside the respective piston rod 37a,37b, an elbow section 124a,124b that extends inside the intermediate body 120, and an end section 126a,126b that extends in extensible tubes 128a,128b sealingly applied to the intermediate body 120, up to a nozzle group 150 applied to the frame 22.

The extensible tubes 128a,128b are suitable to compensate for the variation of position between the intermediate body 120 and the nozzle group 150 due to the movement undergone by the intermediate body 120 during the pre-compression step with respect to the nozzle group 150, which remains fixed.

For example, the tubes 128a,128b have an over-abundant length or are made of extensible material.

For example, the tubes 128a, 128b are made of plastic, for example low-density polyethylene (LDPE) or polyvinyl chloride (PVC).

According to a preferred embodiment, the first delivery duct 40a and the second delivery duct 40b flow into a mixing chamber 152 inside the head 20.

For example, the nozzle group 150 comprises a mixing chamber 152 into which the delivery ducts 40a,40b enter, and in particular their end sections 126a,126b.

For example, the mixing chamber 150 is formed in a nozzle body 154 applied to the frame 22, to which are sealingly applied the two flexible tubes 128a,128b.

Additionally, the nozzle group 150 compress a nozzle mask 156 having a dispensing opening 158 in communication with the mixing chamber 152, administered in a manner rotatable by a user to the nozzle body 154, for example in order to close the dispensing opening 158 by rotation.

According to further variant embodiments, the delivery ducts each comprise a respective dispensing opening for the simultaneous and separate dispensing the two substances to the outside.

Furthermore, the head 20 preferably comprises removable locking means suitable to prevent accidental actuation of the trigger.

For example, the locking means comprise a removable latch 160, suitable to be placed between the frame 22 and the trigger 90 to prevent the actuation of the trigger 90.

For example, the latch 160 is hinged to the frame 22 in a latch hinging point 162 and presents an anchoring portion 164 suitable to couple itself to a protrusion 166 of the frame 22.

Preferably, the latch 160 and the trigger 90 can be snap-coupled to each other.

In a locked configuration, the latch 160 is in an angular position in which it obstructs the actuation of the trigger 90 and the anchoring portion 164 is coupled to the protrusion 166 of the frame, so that the latch 160 stably maintains the position.

Preferably, in the configuration, the latch 160 is snap-coupled with the trigger 90.

For rotation by a user, the anchoring portion 164 disengages from the protrusion 166 (and preferably the latch 160 and the trigger 90 release the mutual snap coupling) and the latch 160 is brought into an angular position in which it does not obstruct the actuation of the trigger 90.

The head 20 further comprises a cover 170, snap-coupleable to the frame 22.

In particular, the frame 22 comprises a rear fin 172, projecting externally from the coupling head wall 24 on the part opposite the trigger 90, the side fins 174, projecting from one side and the other of the frame 22, above the coupling head wall 24, and front side fins 178,180, projecting from one side and the other of the frame 22 in the vicinity of the nozzle group 150, all snap-coupled with the cover 170.

Innovatively, the device according to this invention meets the needs of the sector, since it achieves an excellent mixing of the two substances thanks to the separate and simultaneous compression of both substances immediately before being combined with each other.

In other words, the pre-compression of the two substances prior to their combination, makes the mixing particularly effective, both in the event that it takes place in a mixing chamber inside the device and when it takes place on the object to be treated, for example a surface to be cleaned.

Advantageously, moreover, the assembly of the device is particularly fast and efficient, thanks to the snap connection between the head and the bottle. This advantage is especially appreciated in the sector, given the enormous volume of production.

According to a further advantageous aspect, the device is very reliable, thanks to the robust mechanism which ensures the actuation of the pistons in response to the actuation of the trigger.

Advantageously, moreover, the application of the dispensing head to the bottle is particularly fast, to the advantage of high-volume production.

According to further embodiments, the check valves comprise a flexible membrane deformable by the action of the pressure in the pressure chamber.

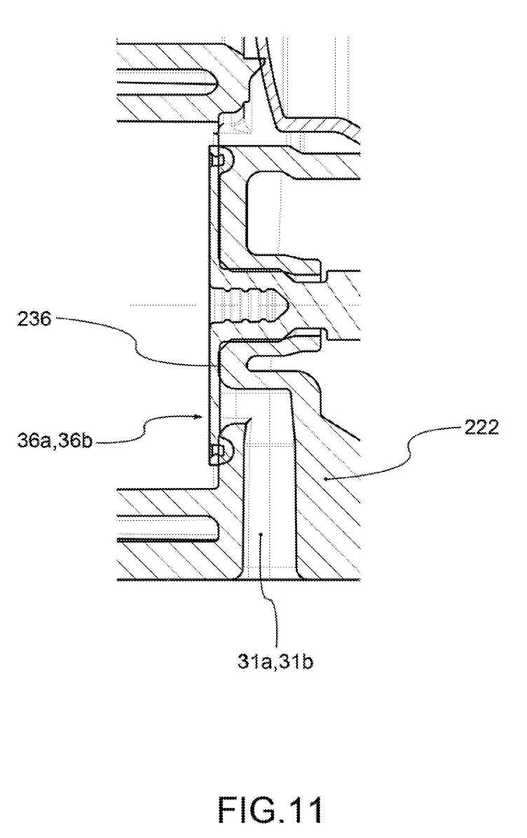

For example, according to an embodiment (FIG. 11), the check valve 36a,36b comprises a flexible membrane 236, affixed to the frame 222.

According to further embodiments, the pre-compression valve comprises a flexible membrane deformable by the action of the threshold pressure in the pressure chamber.

For example, the pre-compression valve 42a,42b is made in a single piece, for example in plastic, and comprises a deformable membrane 242, for example of a convex shape towards the respective delivery duct 40a,40b, and a sleeve 244 for positioning in a valve seat 246 of the frame 22.

For example, the sleeve 244 is coupled to the frame 22. According to a variant embodiment, the pre-compression valve means comprise a latch member applicable to the frame to clamp the sleeve to the frame.

What is claimed is:

1. A trigger head for a dispensing device comprising:
a trigger;
at least one pump;
a first delivery duct;
a second delivery duct; and
a nozzle group;
wherein the at least one pump is operable by the trigger and suitable for carrying out a predetermined pre-compression of at least two substances, separately and simultaneously before dispensing;
wherein the first delivery duct and the second delivery duct are separately attached to the nozzle group allowing the two substances to remain separate before entering the nozzle group.

2. The trigger head of claim 1, wherein the first delivery duct and the second delivery duct comprise a flexible tubes and each of the flexible tubes are directly connected to the nozzle group to minimize any premixing of the at least two substances.

3. The trigger head of claim 2, wherein the flexible tubes have an over-abundant length or are made of extensible material.

4. The trigger head of claim 1, wherein the first delivery duct and the second delivery duct have different lengths.

5. The trigger head of claim 1, wherein each of the at least one pump comprises a pre-compression valve suitable to pass a substance from a pressure chamber to a first delivery duct when the pressure of the substance in the pressure chamber exceeds a predefined threshold pressure and suitable to prevent transit of the substance from the pressure chamber to a first delivery duct when the pressure of the substance in the pressure chamber is less than the predefined threshold pressure.

6. The trigger head according to claim 5, wherein the predefined pressure threshold is greater than 1 bar.

7. The trigger head according to claim 5, wherein the at least one pre-compression valve comprise a first pre-compression valve, operating between a first pressure chamber and the first delivery duct, and a second pre-compression valve, operating between a second pressure chamber and the second delivery duct.

8. The trigger head according to claim 7, wherein the first pre-compression valve comprises a first obturator plate and the second pre-compression valve comprises a second obturator plate.

9. The trigger head according to claim 7, wherein the first pre-compression valve comprises a first flexible membrane deformable by an action of the predefined threshold pressure in the first pressure chamber and the second pre-compression valve comprises a second flexible membrane deformable by the action of the predefined threshold pressure in the second pressure chamber.

10. A trigger head for a dispensing device comprising:
a trigger;
a pump, operable by the trigger and suitable for carrying out a predetermined pre-compression of at least two substances, separately and simultaneously before dispensing;
a first delivery duct;
a second delivery duct;
a nozzle group; and
an actuator, operable by the trigger, wherein the actuator comprises a transmission member, hinged to a frame and engageable by the trigger, via an intermediate body
wherein the first delivery duct and the second delivery duct are separately attached to the nozzle group allowing the two substances to remain separate before entering the nozzle group.

11. The trigger head of claim 10, wherein said intermediate body varies in position during pre-compression.

12. The trigger head of claim 11, wherein the first delivery duct and the second delivery duct each comprise a flexible tube which connects to the intermediate body separately and are suitable for compensating for changes in position between the intermediate body to the nozzle group during pre-compression.

13. The trigger head of claim 11, wherein the transmission member is hinged to a frame at a pivot point so that a rotation of the trigger corresponds to a counter-rotation of the transmission member.

14. The trigger head according to claim 10, wherein each of the pump comprises a suction valve suitable to allow transit of a substance from a containment compartment of a bottle of the dispensing device to a pressure chamber in which a piston operates during a suction phase and prevent return of the substance from the pressure chamber to the containment compartment during a pre-compression step.

15. The trigger head according to claim 14, wherein the suction valve comprises a first check valve, positioned between a first inlet opening and a first pressure chamber; and a second check valve, positioned between a second inlet opening and a second pressure chamber.

16. The trigger head according to claim 15, wherein the first check valve comprises a first obturator sensitive to the action of the substance present in the first pressure chamber and the second check valve comprises a second obturator sensitive to the action of the substance present in the second pressure chamber.

17. A trigger head for a dispensing device comprising:
a trigger;
a first pump and a second pump, operable by the trigger and suitable for carrying out a predetermined pre-compression of at least two substances, separately and simultaneously before dispensing;
a first delivery duct;
a second delivery duct;
a nozzle group; and
an actuator, operable by the trigger, wherein the actuator comprises a transmission member, hinged to a frame and engageable by the trigger, via an intermediate body;
wherein the first delivery duct and the second delivery duct are separately attached to the nozzle group allowing the two substances to remain separate before entering the nozzle group.

18. The trigger head according to claim 17, wherein a first axis of a first pump is positioned behind a second axis of a second and in the same plane.

19. The trigger head according to claim 17, wherein a first delivery duct comprises a first section which extends through the intermediate body, and a second delivery duct comprises a second section which extends through the intermediate body.

20. The trigger head of claim 19, wherein the first section and the second section have different lengths.

21. The trigger head of claim 19, wherein the first section is positioned above and in the same plane as the second section.

22. The trigger head of claim 19, wherein a first extendible tube is positioned above and in the same plane as a second extendible tube.

23. The trigger head according to claim 21, wherein a nozzle group attached to a frame and extendible tubes sealingly attached to the nozzle group and to the intermediate body, which define sections of the delivery ducts, the extendible tubes being suitable to offset a position variation between the intermediate body and the nozzle group due to movement undergone by the intermediate body during a pre-compression step.
